(19) United States
(12) Patent Application Publication
(10) Pub. No.: US 2014/0176049 A1
(43) Pub. Date: Jun. 26, 2014

(54) CHARGING DEVICE

(71) Applicants: Takashi Yamada, Gifu (JP); Yoshihiro Ikushima, Aichi (JP); Takayuki Kawamoto, Nara (JP)

(72) Inventors: Takashi Yamada, Gifu (JP); Yoshihiro Ikushima, Aichi (JP); Takayuki Kawamoto, Nara (JP)

(73) Assignee: OMRON AUTOMOTIVE ELECTRONICS CO., LTD., Aichi (JP)

(21) Appl. No.: 14/138,845

(22) Filed: Dec. 23, 2013

(30) Foreign Application Priority Data
Dec. 25, 2012 (JP) 2012-281069

(51) Int. Cl. H02J 7/02

(52) U.S. Cl. CPC H02J 7/025
USPC 320/107

(57) ABSTRACT

A charging device has a rectifier circuit that rectifies an AC voltage supplied from an AC power supply, a power factor correction circuit that is connected to an output terminal of the rectifier circuit, a capacitor that is connected to a pair of output lines of the power factor correction circuit, a DC-DC converter that boosts or steps down an output voltage at the power factor correction circuit to output the output voltage to a battery, a voltage detection circuit that is provided between the power factor correction circuit and the DC-DC converter, and a controller that controls the power factor correction circuit based on a voltage detected by the voltage detection circuit. The voltage detection circuit includes an isolation transformer, a switching element, and a voltage detector.

### BACKGROUND OF THE INVENTION

1. Technical Field

The present invention relates to a charging device including a power factor correction circuit.

2. Related Art

An electric automobile or a hybrid car is equipped with a high-voltage battery of a driving source for a running motor, and is provided with a charging device in order to charge the high-voltage battery. Usually the charging device includes a power factor correction circuit (hereinafter referred to as a PFC (Power Factor Correction) circuit) and a DC-DC converter. The PFC circuit corrects a power factor by bringing a waveform of an input current close to a waveform of an input voltage. The DC-DC converter boosts or steps down an output voltage at the PFC circuit, and generates a DC voltage for charging the battery.

Each of Re-publication of International Patent Publication No. WO2009/004847 and Japanese Unexamined Patent Publication No. 2009-213350 discloses a power supply device including a PFC circuit and a DC-DC converter that is connected to a subsequent stage of the PFC circuit. A current transformer that detects a drain current of a switching element of the PFC circuit and a bias winding of an inductor of the PFC circuit are provided in the power supply device disclosed in Re-publication of International Patent Publication No. WO2009/004847. A DSP (Digital Signal Processor) is connected to a secondary winding of a transformer included in the DC-DC converter. The DSP obtains an average value of a current passing through an inductor of the PFC circuit based on a secondary-side output of the current transformer or the output voltage at the bias winding, and the DSP controls the switching element of the PFC such that the average value follows the waveform of the input voltage.

In the power supply device disclosed in Japanese Unexamined Patent Publication No. 2009-213350, the output of the PFC circuit is provided to both the DC-DC converter and a DC-AC inverter. The output of the DC-AC inverter is supplied to a first load through a transformer. The DC-DC converter includes a transformer and a switching element. A primary winding of the transformer and the switching element are connected in series between output lines of the PFC circuit, and a second load is connected to the secondary winding of the transformer.

In the charging device including the PFC circuit, in order to stabilize the voltage supplied to the battery, it is necessary to detect the output voltage at the PFC circuit, and to control on and off operations of the switching element of the PFC circuit based on the detected voltage. Therefore, a voltage detection circuit is provided on the output side of the PFC circuit.

FIG. 7 illustrates an example of the conventional charging device including the PFC circuit. A charging device 300 is disposed between an AC power supply 1 and a battery 6. The charging device 300 includes a rectifier circuit 2, a PFC circuit 3, a capacitor C, a voltage detection circuit 4′, a DC-DC converter 5, and a microcomputer 7. The PFC circuit 3 includes an inductor 11, a diode D1, a switching element Q1, and a PFC controller 12.

The voltage detection circuit 4′ includes resistors R1 and R2 constituting a divider resistor, an isolation amplifier 23, and a voltage detector 24. The DC-DC converter 5 includes a switching circuit (not illustrated), a transformer, a rectifier circuit, and a smoothing circuit. Based on the voltage detected by the voltage detection circuit 4′, the microcomputer 7 controls the on and off operations of the switching element Q1 through the PFC controller 12 such that a predetermined voltage is output from the PFC circuit 3.

In the charging device 300, the divider resistors R1 and R2 are provided in the voltage detection circuit 4′ to detect the output voltage at the PFC circuit 3. The output voltage at the PFC circuit 3 is a high voltage because of a boosting action of the switching element Q1 and inductor 11. On the other hand, the voltage detector 24 and the microcomputer 7 operate at a low voltage. For this reason, the high voltage divided by the divider resistors R1 and R2 is provided to the voltage detector 24 through the isolation amplifier 23 to electrically isolate the high-voltage side and the low-voltage side from each other, whereby the current on the high-voltage side is not mistakenly passed through the low-voltage side. Therefore, it is necessary to provide the expensive isolation amplifier 23.

### SUMMARY

A charging device according to one or more embodiments of the present invention can detect the high voltage without use of the isolation amplifier while the high-voltage side and the low-voltage side are electrically isolated from each other.

In accordance with one or more embodiments of the present invention, a charging device includes: a rectifier circuit that rectifies an AC voltage supplied from an AC power supply; a power factor correction circuit that is connected to an output terminal of the rectifier circuit; a capacitor that is connected to a pair of output lines of the power factor correction circuit; a DC-DC converter that boosts or steps down an output voltage at the power factor correction circuit to output the output voltage to a battery; a voltage detection circuit that is provided between the power factor correction circuit and the DC-DC converter; and a controller that controls the power factor correction circuit based on a voltage detected by the voltage detection circuit. In the charging device, the voltage detection circuit includes an isolation transformer, a switching element, and a voltage detector, a primary winding of the isolation transformer and the switching element are connected in series between the pair of output lines of the power factor correction circuit, the voltage detector is connected to a secondary winding of the isolation transformer, and the voltage detector detects an output voltage at the secondary winding of the isolation transformer while the switching element is turned on.

According to the configuration, when the switching element is turned on, the current is passed through the primary winding of the isolation transformer based on the output voltage at the power factor correction circuit, and the voltage proportional to the output voltage emerges in the secondary winding of the isolation transformer. Accordingly, the voltage detector detects the voltage, which allows the output voltage at the power factor correction circuit to be obtained by the calculation. Therefore, the output voltage at the power factor correction circuit can be detected while the high-voltage side and the low-voltage side are electrically isolated from each other using the inexpensive isolation transformer, and the necessity of the expensive isolation amplifier is eliminated.

According to one or more embodiments of the present invention, the switching element of the voltage detection circuit is driven by a pulse signal having a short pulse width in which the output voltage at the power factor correction circuit does not substantially fluctuate by discharge of the capacitor during on time of the switching element.

In accordance with one or more embodiments of the present invention, the voltage detection circuit may be provided on an output side of the DC-DC converter, and the primary winding of the isolation transformer and the switching element may be connected in series between a pair of output lines of the DC-DC converter.

The voltage detector may detect an average value of the output voltage at the secondary winding of the isolation transformer, and the controller may calculate the output voltage at the power factor correction circuit based on the average value of the output voltage and a turn ratio of the isolation transformer.

The voltage detector may detect an average value of the output voltage at the secondary winding of the isolation transformer, and the controller may calculate an output voltage at the DC-DC converter based on the average value of the output voltage and a turn ratio of the isolation transformer.

Accordingly, one or more embodiments of the present invention can provide the charging device that can detect the high voltage without use of the isolation amplifier while the high-voltage side and the low-voltage side are electrically isolated from each other.

### BRIEF DESCRIPTION OF THE DRAWINGS

FIG. 1 is a circuit diagram illustrating a charging device according to a first embodiment of the present invention;

FIG. 2 is a circuit diagram illustrating an example of a DC-DC converter;

FIG. 3 is a diagram illustrating a current path when a switching element is turned on;

FIGS. 4A to 4C are diagrams illustrating a waveform of a signal of each part;

FIG. 5 is a flowchart illustrating a processing procedure of a microcomputer;

FIG. 6 is a circuit diagram illustrating a charging device according to a second embodiment of the present invention; and

FIG. 7 is a diagram illustrating a conventional charging device.

### DETAILED DESCRIPTION

Embodiments of the present invention will be described below with reference to the drawings. In the drawings, identical or equivalent components are designated by identical numerals. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

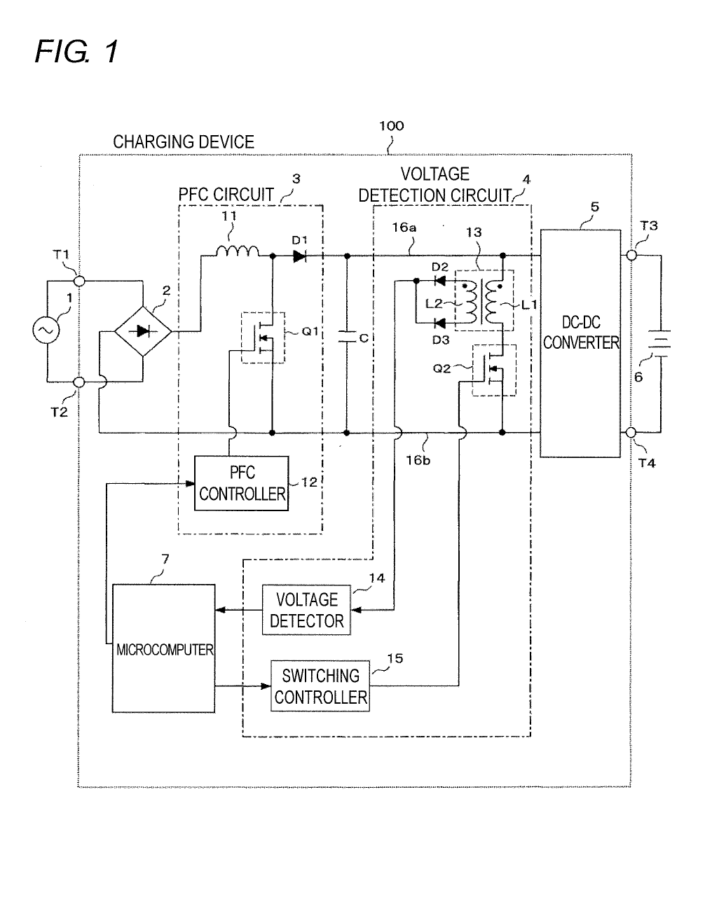

A configuration of a charging device according to a first embodiment of the present invention will be described with reference to FIG. 1.

Referring to FIG. 1, a charging device 100 is disposed between an AC power supply 1 and a battery 6. Therefore, terminals T1 and T2 connected to the AC power supply 1 and terminals T3 and T4 connected to the battery 6 are provided in the charging device 100. For example, the AC power supply 1 is a commercial power supply of AC 100 V. For example, the battery 6 is a secondary battery, such as a lithium-ion battery and a lead storage battery, which is mounted on a vehicle.

The charging device 100 includes a rectifier circuit 2, a PFC (power factor correction) circuit 3, a capacitor C, a voltage detection circuit 4, a DC-DC converter 5, and a microcomputer 7.

The rectifier circuit 2 includes a full-wave rectifier circuit to perform full-wave rectification to an AC voltage supplied from the AC power supply 1 through the terminals T1 and T2. The PFC circuit 3 is connected to an output terminal of the rectifier circuit 2, and includes an inductor 11, a diode D1, a switching element Q1, and a PFC controller 12.

One end of the inductor 11 is connected to one of the output terminals of the rectifier circuit 2, and the other end is connected to an anode of the diode D1. The switching element Q1 includes an FET (Field Effect Transistor). A drain of the switching element Q1 is connected to a connection point of the inductor 11 and the diode D1, and a source of the switching element Q1 is connected to the other output terminal of the rectifier circuit 2. A gate of the switching element Q1 is connected to the PFC controller 12.

A capacitor C smoothes the voltage output from the PFC circuit 3, and is connected between a pair of output lines 16a and 16b of the PFC circuit 3.

The voltage detection circuit 4 is provided between the PFC circuit 3 and the DC-DC converter 5. The voltage detection circuit 4 includes an isolation transformer 13, a switching element Q2, a voltage detector 14, and a switching controller 15. The isolation transformer 13 includes a primary winding L1 and a secondary winding L2. The switching element Q2 includes the FET similarly to the switching element Q1.

The primary winding L1 of the isolation transformer 13 and the switching element Q2 are connected in series between the output lines 16a and 16b of the PFC circuit 3. Particularly, one end of the primary winding L1 is connected to the output line 16a, and the other end is connected to the drain of the switching element Q2. The source of the switching element Q2 is connected to the output line 16b. The gate of the switching element Q2 is connected to the switching controller 15. The secondary winding L2 of the isolation transformer 13 is connected to the voltage detector 14 through rectifying diodes D2 and D3.

In the voltage detector 14, the output voltage at the secondary winding L2 of the isolation transformer 13 is smoothed using a capacitor (not illustrated) to detect an average value of the output voltage.

The switching controller 15 controls the on and off operations of the switching element Q2, and outputs a PWM (Pulse Width Modulation) signal having a predetermined duty to the gate of the switching element Q2.

The microcomputer 7 constitutes a controller of one or more embodiments of the present invention, and controls the PFC circuit 3 through the PFC controller 12 based on the voltage detected by the voltage detection circuit 4. The microcomputer 7 also controls the switching controller 15.

The PFC controller 12 controls the on and off operations of the switching element Q1 in response to a command from the microcomputer 7. The PFC controller 12 outputs the PWM signal having the predetermined duty to the gate of the switching element Q1.

The DC-DC converter 5 boosts or steps down the output voltage at the PFC circuit 3, and outputs the output voltage to the battery 6 through the terminals T3 and T4.

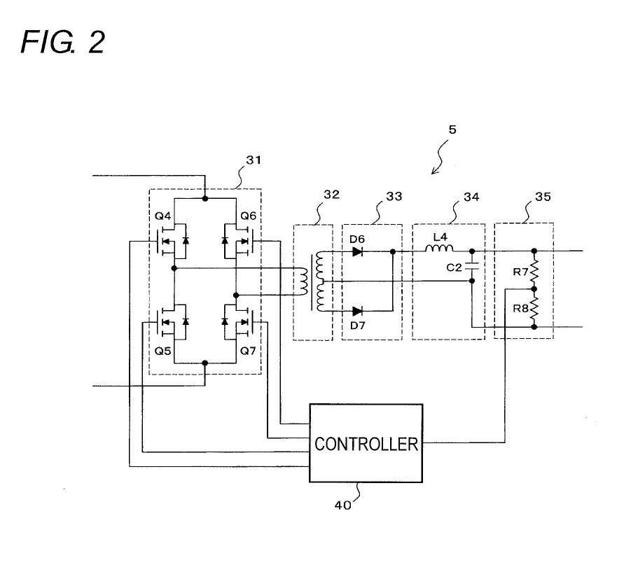

FIG. 2 illustrates an example of the DC-DC converter 5. The DC-DC converter 5 is a well-known circuit including a switching circuit 31, a transformer 32, a rectifier circuit 33, a smoothing circuit 34, and an output voltage detection circuit 35. A controller 40 includes a microcomputer.

The switching circuit 31 includes four switching elements Q4 to Q7 in which bridge connection is formed, and the switching circuit 31 converts the DC voltage output from the PFC circuit 3 into the AC voltage. The transformer 32 boosts or steps down the AC voltage output from the switching circuit 31. The rectifier circuit 33 includes two diodes D6 and D7, and converts the AC voltage generated on the secondary side of the transformer 32 into the pulsed DC voltage.

The smoothing circuit 34 includes a lowpass filter that includes an inductor L4 and a capacitor C2. The smoothing circuit 34 smoothes the voltage output from the rectifier circuit 33. The battery 6 (see FIG. 1) is charged by the output voltage at the smoothing circuit 34. The output voltage detection circuit 35 includes series-connected divider resistors R7 and R8, detects the output voltage at the smoothing circuit 34, and transmits the detected output voltage to the controller 40. The controller 40 performs feedback control based on the output voltage detected by the output voltage detection circuit 35, and controls the on and off operations of the switching elements Q4 to Q7 of the switching circuit 31.

The operation of the charging device 100 having the above configuration will be described below.

The operation of the PFC circuit 3 will briefly be described because the operation of the PFC circuit 3 is similar to conventional ones. In the PFC circuit 3, the switching element Q1 performs a high-speed switching operation under the control of the PFC controller 12. A current waveform similar to a voltage waveform (sine wave) of the input voltage supplied from the AC power supply 1 is generated by the switching operation, and the current waveform comes close to the sine wave to correct a power factor. At this point, the inductor 11 and the diode D1 perform the boost and the rectification of the voltage.

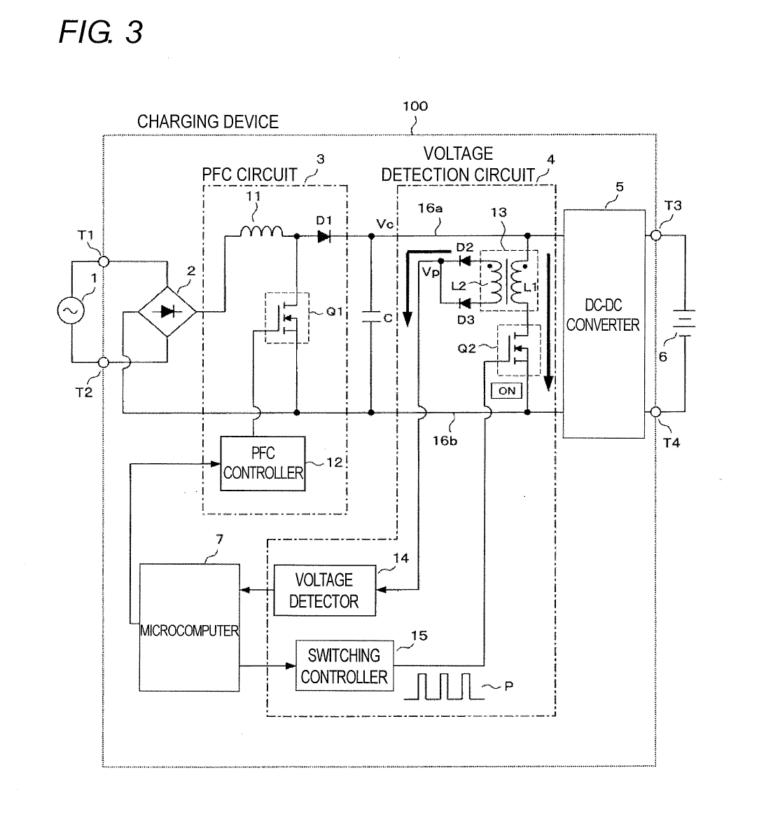

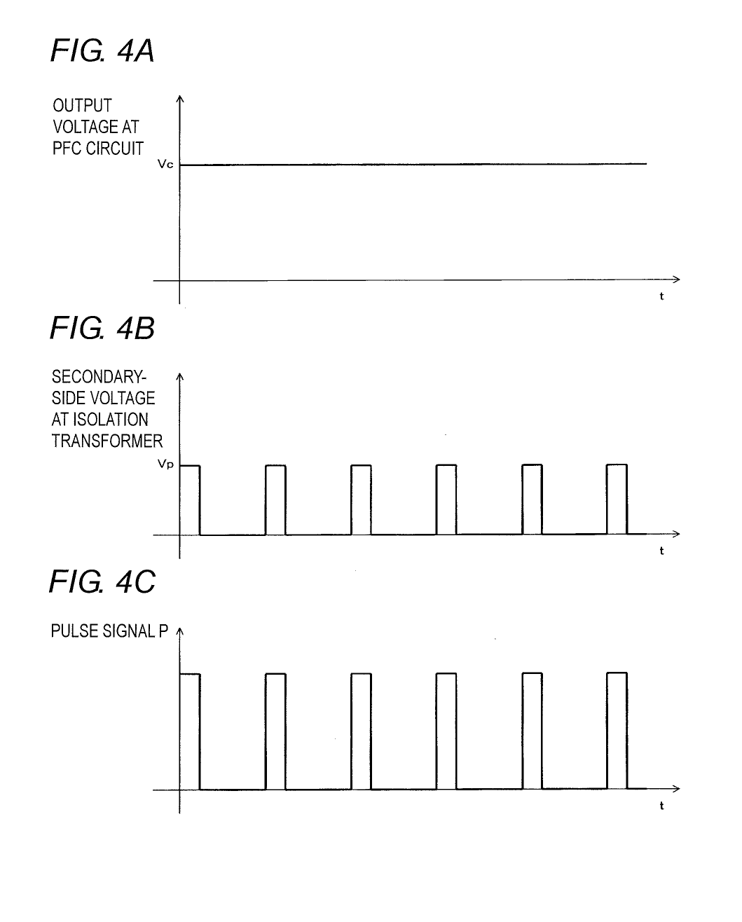

The operation of the voltage detection circuit 4 will be described in detail with reference to FIGS. 3 to 5. Referring to FIG. 3, the voltage input to the voltage detection circuit 4, namely, an output voltage Vc at the PFC circuit 3 is smoothed by the capacitor C. Therefore, the output voltage Vc is the substantially constant DC voltage as illustrated in FIG. 4A (however, actually the output voltage Vc includes a pulsating component).

The microcomputer 7 manages the timing when the voltage detection circuit 4 detects the voltage. The microcomputer 7 issues a voltage detection command to the switching controller 15 when the timing of voltage detection comes. In response to the voltage detection command, the switching controller 15 outputs a pulse signal P illustrated in FIG. 4C to the gate of the switching element Q2. The pulse signal P is the PWM signal having the predetermined duty.

The switching element Q2 is turned on in an H (High) interval of the pulse signal P, and turned off in an L (Low) interval. A current path indicated by a bold arrow in FIG. 3 is formed in the on state of the switching element Q2. That is, the current is passed through the primary winding L1 of the isolation transformer 13 and the switching element Q2 based on the output voltage Vc at the PFC circuit 3. The voltage is induced in the secondary winding L2 of the isolation transformer 13 by excitation of the primary winding L1, and the current is passed from the secondary winding L2 to the voltage detector 14 through the diodes D2 and D3, based on the induced voltage.

An output voltage Vp at the secondary winding L2 emerges only in the H interval (the on interval of the switching element Q2) of the pulse signal P as illustrated in FIG. 4B. The voltage detector 14 takes in the output voltage Vp of the pulse waveform, and smoothes the output voltage Vp using the capacitor (not illustrated) as described above, thereby detecting the average value of the output voltage Vp. The output of the voltage detector 14 is output to the microcomputer 7.

The microcomputer 7 calculates the output voltage Vc at the PFC circuit 3 based on the average value of the output voltage Vp read from the voltage detector 14 and a turn ratio of the isolation transformer 13. Specifically, assuming that Vp is the average value of the output voltage at the secondary winding L2, and that N is the turn ratio of the isolation transformer 13, the output voltage Vc at the PFC circuit 3 can be calculated by the following equation.

Vc=Vp·(1/N) (1)

The microcomputer 7 performs the feedback control to the PFC circuit 3 such that the output voltage Vc is equal to a predetermined value (target value). Particularly, the microcomputer 7 compares the calculated value and target value of the output voltage Vc to obtain a difference between the calculated value and the target value. The microcomputer 7 issues the command related to the duty of the PWM signal to the PFC controller 12 such that the difference is zero. The PFC controller 12 generates the PWM signal having the duty corresponding to the command, and outputs the PWM signal to the gate of the switching element Q1. As a result, on time and off time of the switching element Q1 are properly controlled, and the stable voltage is output from the PFC circuit 3.

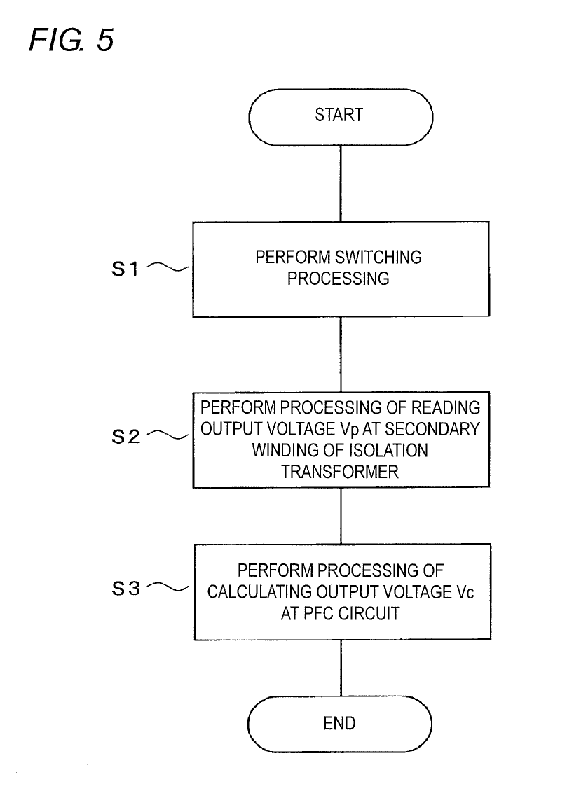

A flowchart in FIG. 5 illustrates a processing procedure of the microcomputer 7 during the voltage detection. In Step S1, the microcomputer 7 performs the switching processing when the timing of voltage detection comes. In the switching processing, the microcomputer 7 issues the voltage detection command to the switching controller 15. The on and off operations of the switching element Q2 is performed by the pulse signal P output from the switching controller 15.

In Step S2, the microcomputer 7 performs the processing of reading the output voltage Vp (average value) at the secondary winding L2 of the isolation transformer 13 from the voltage detector 14. Because the voltage detector 14 outputs an analog value, the microcomputer 7 perform the processing (A-D conversion) of converting the read voltage into a digital value. The A-D conversion processing is eliminated in the case that the voltage detector 14 includes an A-D converter.

In Step S3, the microcomputer 7 performs the processing of calculating the output voltage Vc at the PFC circuit 3. In the calculation processing, the microcomputer 7 calculates the output voltage Vc according to the equation (1).

The pulse signal P applied to the gate of the switching element Q2 is the PWM signal having the small duty as illustrated in FIG. 4C. For example, the pulse signal P has a frequency of 100 KHz and a duty of 10%. In this case, a pulse width of the pulse signal P, namely, the on time of the switching element Q2 is 1 μsec.

The on time of the switching element Q2 increases with increasing pulse width of the pulse signal P, which increases a discharge amount from the capacitor C to the switching element Q2. Therefore, a fluctuation in output voltage Vc at the PFC circuit 3 is prominent, and the operation of the PFC circuit 3 is unstable. A power loss increases because energization time of the switching element Q2 is lengthened.

On the other hand, in the first embodiment, the pulse signal P has the small pulse width and the on time of the switching element Q2 is short. Therefore, the discharge amount of the capacitor C is a little. Accordingly, the output voltage Vc at the PFC circuit 3 hardly fluctuates and the operation of the PFC circuit 3 is stabilized. Additionally, the power loss can be suppressed because of the short energization time of the switching element Q2.

According to one or more embodiments of the present invention, the switching element Q2 is driven by the pulse signal P having a short pulse width in which the output voltage Vc at the PFC circuit 3 does not substantially fluctuate by the discharge of the capacitor C during the on time of the switching element Q2.

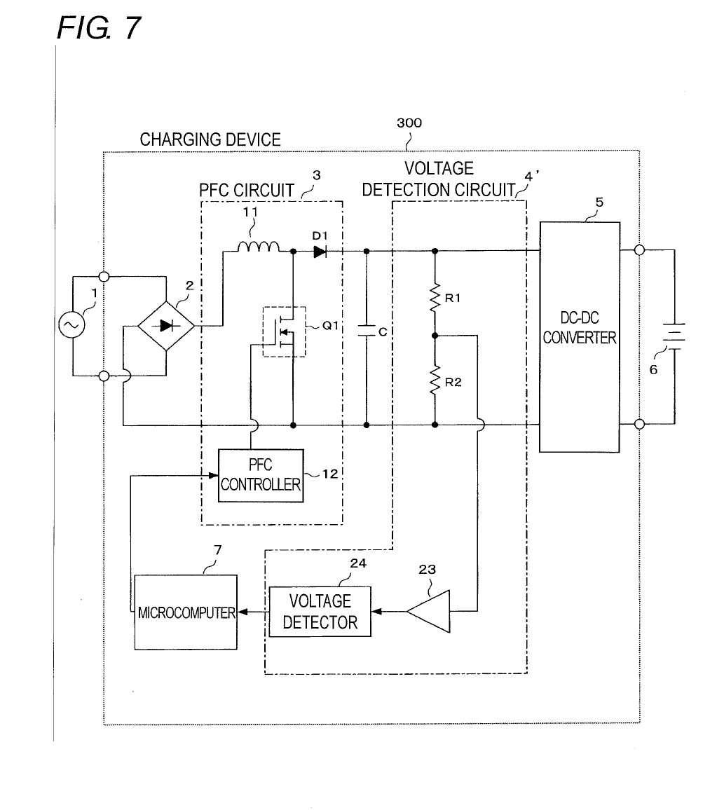

According to the first embodiment, when the switching element Q2 is turned on, the current is passed through the primary winding L1 of the isolation transformer 13 based on the output voltage Vc at the PFC circuit 3, and the voltage Vp proportional to the output voltage Vc emerges at the secondary winding L2 of the isolation transformer 13. Accordingly, the voltage Vp is detected by the voltage detector 14, which allows the output voltage Vc at the PFC circuit 3 to be obtained by the calculation of the equation (1). Therefore, the output voltage Vc at the PFC circuit 3 can be detected while the high-voltage side and the low-voltage side are electrically isolated from each other using the inexpensive isolation transformer 13, and the necessity of the expensive isolation amplifier 23 in FIG. 7 is eliminated.

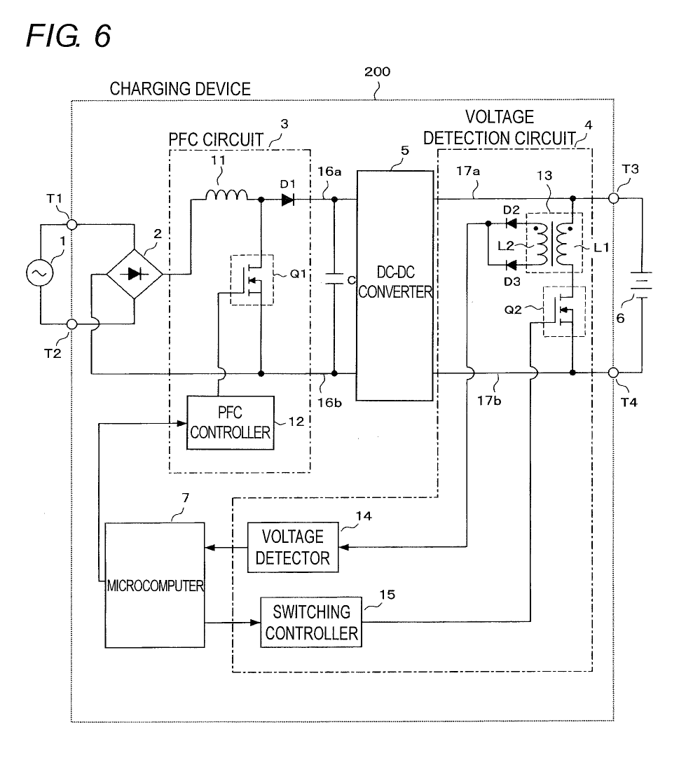

A configuration of a charging device according to a second embodiment of the present invention will be described with reference to FIG. 6.

In a charging device 200 in FIG. 6, the voltage detection circuit 4 is provided on the output side of the DC-DC converter 5. The configuration of the voltage detection circuit 4 is identical to that of the first embodiment (see FIG. 1). The primary winding L1 of the isolation transformer 13 and the switching element Q2 are connected in series between a pair of output lines 17a and 17b of the DC-DC converter 5. Because other configurations are identical to those in FIG. 1, the description is neglected.

In the charging device 100 of the first embodiment, the voltage detection circuit 4 detects the output voltage at the PFC circuit 3. On the other hand, in the charging device 200 of the second embodiment, the voltage detection circuit 4 detects the output voltage at the DC-DC converter 5. Because the output voltage at the DC-DC converter 5 bears a constant relationship with the output voltage at the PFC circuit 3, the output voltage at the secondary winding L2 of the isolation transformer 13 in the voltage detection circuit 4 also bears a constant relationship with the output voltage at the PFC circuit 3.

Accordingly, the voltage detector 14 detects the average value of the output voltage at the secondary winding L2 of the isolation transformer 13, which allows the microcomputer 7 to calculate the output voltage at the PFC circuit 3 based on the average value of the output voltage at the secondary winding L2 and the turn ratio of the isolation transformer 13.

In the charging device 200 of the second embodiment, the voltage detection circuit 4 is provided on the output side of the DC-DC converter 5, so that output voltage detection circuit 35 in FIG. 2 can be eliminated. In this case, the voltage detector 14 may detect the average value of the output voltage at the secondary winding L2 of the isolation transformer 13, and the microcomputer 7 may calculate the output voltage at the DC-DC converter 5 based on the average value and the turn ratio of the isolation transformer 13. The microcomputer 7 issues the command related to the duty of the PWM signal to controller 40 (see FIG. 2) of the DC-DC converter 5 based on the calculated output voltage, thereby performing the feedback control.

In the second embodiment, similarly to the first embodiment, the output voltage Vc at the PFC circuit 3 can be detected while the high-voltage side and the low-voltage side are electrically isolated from each other using the inexpensive isolation transformer 13, and the necessity of the expensive isolation amplifier 23 in FIG. 7 is eliminated.

Various embodiments in addition to the above embodiments are within the scope of the present invention. In one or more of the above embodiments, by way of example, the PFC controller 12, the voltage detector 14, and the switching controller 15 are provided independently of the microcomputer 7. Alternatively, the functions of the parts 12, 14, and 15 may be incorporated in the microcomputer 7.

In one or more of the above embodiments, by way of example, the switching elements Q1 and Q2 are driven using the PWM signal. Alternatively, the switching elements Q1 and Q2 may be driven using a pulse signal that is not the PWM signal.

In one or more of the above embodiments, by way of example, the boost type PFC circuit 3 boosts the input voltage. However, one or more embodiments of the present invention can also be applied to a step-down type PFC circuit that steps down the input voltage.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A charging device comprising:
a rectifier circuit that rectifies an AC voltage supplied from an AC power supply;
a power factor correction circuit that is connected to an output terminal of the rectifier circuit;
a capacitor that is connected to a pair of output lines of the power factor correction circuit;
a DC-DC converter that boosts or steps down an output voltage at the power factor correction circuit to output the output voltage to a battery;
a voltage detection circuit that is provided between the power factor correction circuit and the DC-DC converter; and
a controller that controls the power factor correction circuit based on a voltage detected by the voltage detection circuit,
wherein the voltage detection circuit includes an isolation transformer, a switching element, and a voltage detector,
wherein a primary winding of the isolation transformer and the switching element are connected in series between the pair of output lines of the power factor correction circuit,
wherein the voltage detector is connected to a secondary winding of the isolation transformer, and
wherein the voltage detector detects an output voltage at the secondary winding of the isolation transformer while the switching element is turned on.

2. The charging device according to claim 1, wherein the switching element is driven by a pulse signal having a short pulse width in which the output voltage at the power factor correction circuit does not substantially fluctuate by discharge of the capacitor during on time of the switching element.

3. A charging device comprising:
a rectifier circuit that rectifies an AC voltage supplied from an AC power supply;
a power factor correction circuit that is connected to an output terminal of the rectifier circuit;
a capacitor that is connected to a pair of output lines of the power factor correction circuit;
a DC-DC converter that boosts or steps down an output voltage at the power factor correction circuit to output the output voltage to a battery;
a voltage detection circuit that is provided on an output side of the DC-DC converter; and
a controller that controls the power factor correction circuit based on a voltage detected by the voltage detection circuit,
wherein the voltage detection circuit includes an isolation transformer, a switching element, and a voltage detector,
wherein a primary winding of the isolation transformer and the switching element are connected in series between a pair of output lines of the DC-DC converter,
wherein the voltage detector is connected to a secondary winding of the isolation transformer, and
wherein the voltage detector detects an output voltage at the secondary winding of the isolation transformer while the switching element is turned on.

4. The charging device according to claim 1,
wherein the voltage detector detects an average value of the output voltage at the secondary winding of the isolation transformer, and
wherein the controller calculates the output voltage at the power factor correction circuit based on the average value of the output voltage and a turn ratio of the isolation transformer.

5. The charging device according to claim 3,
wherein the voltage detector detects an average value of the output voltage at the secondary winding of the isolation transformer, and
wherein the controller calculates an output voltage at the DC-DC converter based on the average value of the output voltage and a turn ratio of the isolation transformer.

6. The charging device according to claim 2,
wherein the voltage detector detects an average value of the output voltage at the secondary winding of the isolation transformer, and
wherein the controller calculates the output voltage at the power factor correction circuit based on the average value of the output voltage and a turn ratio of the isolation transformer.

7. The charging device according to claim 3,
wherein the voltage detector detects an average value of the output voltage at the secondary winding of the isolation transformer, and
wherein the controller calculates the output voltage at the power factor correction circuit based on the average value of the output voltage and a turn ratio of the isolation transformer.
